(19) United States
(12) Patent Application Publication
(10) Pub. No.: US 2015/0260116 A1
(43) Pub. Date: Sep. 17, 2015

(54) SYSTEM FOR CONTROLLING AN EGR VALVE OF AN INTERNAL COMBUSTION ENGINE BASED ON A FLOW MODEL

(71) Applicant: FPT INDUSTRIAL S.P.A., Torino (IT)

(72) Inventor: Fabio Odello, Colegno (IT)

(21) Appl. No.: 14/439,827

(22) PCT Filed: Nov. 6, 2013
(86) PCT No.: PCT/IB2013/059933

§ 371 Date: Apr. 30, 2015

(30) Foreign Application Priority Data
Nov. 6, 2012 (EP) 12191361.0

(51) Int. Cl. F02D 41/00

(52) U.S. Cl. CPC F02D 41/0077; F02D 41/0072

(57) ABSTRACT

System for controlling an EGR valve of an internal combustion engine based on a flow model, the flow model estimating an EGR flow rate outgoing from the EGR valve to control an opening/closing of said EGR valve, on the basis of operating parameters of the internal combustion engine; the method being characterized in that it models said EGR valve as a nozzle and it calculates a relative equivalent outflow area to correct said estimation of the EGR flow rate.

### CROSS REFERENCE TO RELATED APPLICATIONS

The present application claims priority to PCT International Application No. PCT/IB2013/059933 filed on Nov. 6, 2013, which application claims priority to European Patent Application No. 12191361.0 filed Nov. 6, 2012, the entirety of the disclosures of which are expressly incorporated herein by reference.

### STATEMENT RE: FEDERALLY SPONSORED RESEARCH/DEVELOPMENT

Not Applicable.

### APPLICATION FIELD OF THE INVENTION

The present invention refers to the field of the systems for controlling the EGR valve, of the sensorless type, namely wherein neither a mass flow sensor nor another equivalent sensor are present for measuring directly the air mass/flow rate entering the internal combustion engine.

### DESCRIPTION OF THE PRIOR ART

The emission regulations for internal combustion engines require stricter and stricter emission limits and more and more demanding homologation cycles. One of the pollutants which has the highest impact and which the regulations require to keep under control is Nitrogen Oxide (NOx): the EGR (Exhaust Gas Recirculation) is the system in charge of, in most applications, the reduction of such pollutant.

The traditional EGR control systems are based on the information provided by the intake air flow sensor, also known as “mass flow sensor”, but the calibration of such sensor is highly influenced by the configuration of intake system. Being the latter, in some cases, very variable, the management of the sensor itself can be problematic.

Furthermore the mass flow sensor, especially in so-called “off-road” applications, namely for earthworks machines and for construction vehicles, is affected by the dirt coming from the surrounding environment, which results in a bad control of the engine, both in terms of intake and in terms of EGR.

A control system that is able to manage the EGR system without the help of the mass flow sensor allows to be independent of the previously mentioned factors, making its functioning and its respective calibration more robust.

A known strategy to avoid using a mass flow sensor provides the mapping of the opening value of the EGR valve in relation to engine speed and to load. Such solution is not satisfactory, since it does not allow a robust control of the drifts of any of the components, both due to production uniformity and to the ageing of the components themselves.

Other solutions provide alternative sensors, such as Uhego sensor, Soot sensor, NOx sensor, Pitot tube, etc.

Such sensors are generally expensive and the algorithms exploiting such sensors are not reliable and are affected by several negative aspects, such as the lack of continuous availability of the signals from most. of these sensors: Uhego sensor, just to mention the first one, needs some warming time from the engine starting before being able to provide a reliable signal. Consequently the control of the EGR with cold engine has a very low precision.

The strategies described herein are known in the art, and their different alternative embodiments have been described in the attempt to overcome their limits.

### SUMMARY OF THE INVENTION

The aim of the present invention is to overcome all the drawbacks of the prior art, by providing a control system of the EGR valve of an internal combustion engine.

The object of the present invention is a method for controlling the EGR valve of an internal combustion engine based on a flow model.

In particular, according to the present invention, the EGR valve is modelled as a nozzle from which the recirculated gas flow, in order to calculate an outflow area value and to correct the recirculated gas flow rate according to a flow model. In particular, the recirculated gas flow rate is multiplied by the equivalent outflow area.

According to a preferred embodiment of the present invention, the equivalent outflow area is calculated by a mapping, parameterized with respect to the revolutions per minute of the engine.

According to another preferred alternative embodiment of the present invention, the control scheme is made in closed loop, using the feedback from an EGR mass error recirculated on the same valve model.

According to a further preferred embodiment of the present invention, the feedback line is filtered by a regulator, parameterized with respect to the revolutions per minute of the engine.

According to another preferred alternative embodiment of the invention, said regulator is a function of the quantity of injected fuel.

It is a further object of the present invention a control device of the EGR valve, implementing the aforementioned method.

A further object of the present invention is an internal combustion engine and a ground vehicle comprising said control device of the EGR valve.

The claims are an integral part of the present description.

### BRIEF DESCRIPTION OF THE FIGURES

Further purposes and advantages of the present invention will become clear from the following detailed description of a preferred embodiment (and of its alternative embodiments) and the drawings that are attached hereto, which are merely illustrative and non-limitative, in which:

FIG. 1 shows the control scheme in outline representing the method that is object of the present invention;

FIG. 2 shows an exploded view of the block scheme shown in FIG. 1;

FIG. 3 shows an internal combustion engine comprising means to realize the method schematized in FIG. 1.

In the figures the same reference numbers and letters identify the same elements or components.

### DETAILED DESCRIPTION OF PREFERRED EMBODIMENTS OF THE INVENTION

The method that is object of the invention is described hereinafter, such method allows to perform a continuous control of the opening of the EGR.

The method is described with reference to the functional block diagrams of the attached figures, wherein each block. corresponds to the logic functions performed by the apparatus implementing them.

In line with the language used in the field of the automatic controls, each block can be considered as a filter applied to the respective input variables, regardless of the type of logical operation carried out.

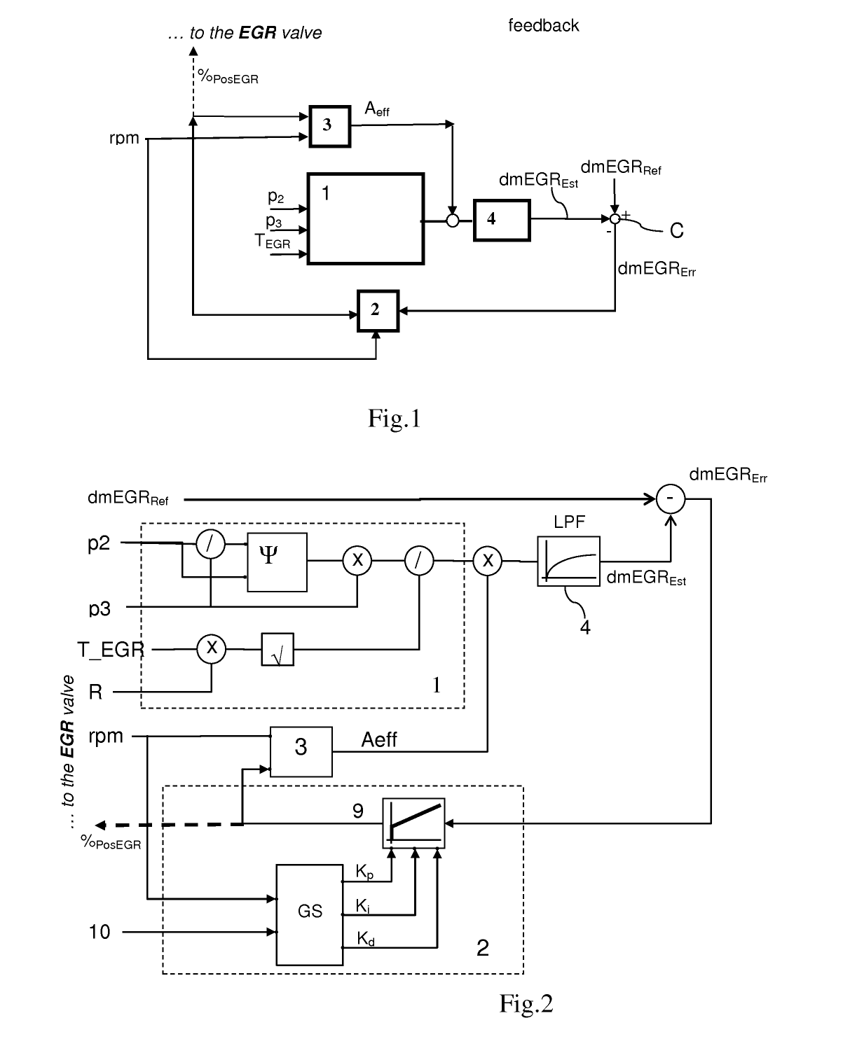

With particular reference to FIG. 1, the block 1 implements a flow model, that can be of the type per se known, wherein
P2: the pressure downstream of the EGR valve, namely at the intake manifold;
P3: the pressure upstream of the EGR valve, namely at the exhaust manifold;
T_EGR: the temperature upstream of the EGR valve, namely the temperature at the exhaust manifold.

Block 3 models the EGR valve as a nozzle, in order to calculate Aeff, namely the equivalent outflow area of the valve.

The output of the block 3 is multiplied by the output of the block 1 defining an estimated quantity/flow rate of EGR, namely the parameter dmEGR_Est.

The flow rate dmEGR_Est of the recirculated gas EGR estimated by the present flow model is used to control the opening/closing of the EGR valve.

When the control scheme receives the feedback, such flow rate dmEGR_Est is compared, by means of a comparator C, with a reference value dmEGR_Ref. The difference between such two values, namely the error dmEGR_Err, is given as a feedback to block 3 which estimates the equivalent outflow area Aeff. Preferably such error value is filtered, on the feedback line, by a regulator 2. Thus the regulation of the opening of the EGR valve, namely the regulation of the outflow area Aeff is controlled by means of a regulator, thus the output of the regulator 2 is also given as a feedback to the block 3 of the flow model.

According to the present invention, the outflow area Aeff is tabulated/mapped. Preferably, the feedback line ends at such table defined by block 3 in order to identify the outflow area value Aeff. Such mapping, preferably, is parameterized on the revolutions per minute of the engine.

Starting from a real valve, laboratory tests have been performed to obtain a table indicating the current Aeff value in relation to the valve opening. Then, when the model has been implemented, it has been realized that the Aeff value is influenced by the engine operating point and in particular by the engine rpm, above all in transient conditions of the whole engine+valve system. In particular, the estimation of the outflow area is wrong with high engine revolutions per minute.

Thus, the introduction of test bench sensors allowed to correct such estimation error, parameterizing the table also on the revolutions per minute of the engine. The same experiment has been repeated on increasingly aged engines, verifying that such inaccuracies are always present. Thus, the introduction of such mapping results is a constant advantage.

Thanks to the presence of a dynamic flow model associated to a high parameterizable closed-loop control, it is possible to modulate the behaviour of the EGR valve in transient conditions according to the needs of each case, in order to obtain the best possible trade-off.

The advantageous properties of the closed-loop, as described in the present invention allow:
to control the dynamics of the transient conditions,
to reject possible disturbances/irregular behaviour of the model inlets (P2, P3, T2, T3),
to use a closed-loop regulator as a filter, which filters unwanted high frequency dynamics. The latter may or may not have a direct connection with the ageing or with constructive problems of the components, in fact, even a new engine may have, in certain conditions, inlet dynamics that may create trouble to an EGR control without closed loop.

Furthermore, the proposed method is based on relatively standard sensors, and allow to avoid the costs connected to the management of more critical sensors in terms of layout, characterization and mounting, such as the mass flow sensor, the Pitot tube, and other particular sensors.

The estimated EGR flow rate dmEGR_Est, as described above, is modelled by means of a flow model, wherein the EGR valve is modelled as a nozzle: the real flow is then assimilated to an equivalent ideal flow, that is stationary, adiabatic and reversible, according to the equation

$$\begin{matrix}{\dot{m}}_{EGR , est} = \frac{{A}_{eff} \cdot {p}_{3} \sqrt{\frac{2 γ}{γ - 1} ( {Π}_{th}^{2 / γ} - {Π}_{th}^{γ + 1 / γ}}}{\sqrt{{RT}_{EGR}}} , & ( 1 ) \\ {Π}_{th} = max ( \frac{{p}_{2}}{{p}_{3}} , {( \frac{2}{γ + 1} )}^{\frac{γ}{γ - 1}} ) & ( 2 )\end{matrix}$$

It is to be noted that the notation \dot{m}_{EGR}_{ₑₛₜ} coincides with dmEGR_Est in the figures.

For more convenience, Ψ indicates the quantity

$$\sqrt{\frac{2 γ}{γ - 1} ( {Π}_{th}^{2 / γ} - {Π}_{th}^{γ + 1 / γ} )} ,$$

so that the equation (1) can be simplified as

$${\dot{m}}_{EGR , est} = \frac{{A}_{eff} \cdot {p}_{3} Ψ}{\sqrt{{RT}_{EGR}}} \qquad ( 3 )$$

The regulator 2 is preferably of the PID type (proportional/integrative/derivative).

According to another aspect of the present invention, the PID is not static, namely it is not based on fixed gains, but on variable gains that can be varied in relation to at least one of the following parameters/operating condition:
engine operating point and, preferably, revolutions per minute;
amplitude of the received error dmEGR_Err;
sign of the received error dmEGR_Err (positive/negative), in order to differentiate the behaviour of the EGR valve during its opening and its closing;
operating condition “normal EGR” or “reduced EGR”: the latter management mode of the EGR has the purpose to protect the engine from a too high grade of smoke, and is enabled according to information such as vehicle speed, engaged gear, vehicle consumption, time passed from the engine starting.

Thus the output of the regulator 2 defines, virtually, a “pre-control” of the opening of the EGR valve, which is immediately modulated by means of the conversion map parameterized on the engine revolutions per minute, represented by block 3.

Preferably, the output of block 1, namely of the block implementing the flow model is filtered by block 4, which implements a low-pass filter.

FIG. 2 shows an exploded view of the block scheme of FIG. 1.

In particular, the block 3 defining a regulator PID which receives in input the position error of the EGR valve and by means of which the opening 9 of the EGR valve is calculated, preferably expressed in percentage % posEGR. At least one of the parameters Kp, Ki and Kd of the controller (proportional, integrative and derivative) are a function of at least the engine revolutions per minute (rpm) and preferably also of the quantity of injected diesel fuel 10. Thus, being the information relating to the quantity of injected fuel and to the current revolutions per minute present in the regulator, it is possible to differentiate the behaviour of the regulator in relation to the transient conditions, namely the sudden accelerations.

As regards the block 1 shown in FIG. 2, it consists of simple mathematical operations to implement the formula (3), with the only exception of the quantity Aeff which is calculated by means of the table of block 3.

It is worth noting that, according to a preferred alternative embodiment of the invention, also the quantity Ψ is calculated by means of a multi-parameter table, in order to reduce, in this case, the computational burden.

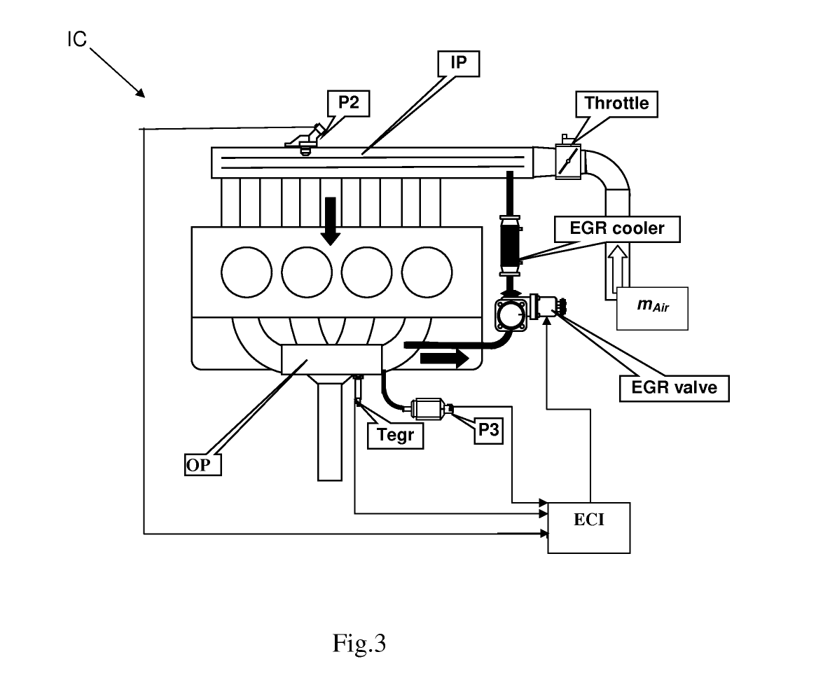

With reference to FIG. 3, an internal combustion engine IC is shown having an intake manifold IP, an exhaust manifold OP and the sensors p2, p3 and T_Egr arranged as described above.

The control unit ECI, on the basis of the values measured by such sensors, regulates the opening/closing of the EGR valve.

Advantageously, the method described herein, with its alternative embodiments, may be easily implemented in an engine control unit ECI, which is also part of the present invention. Thus, the present invention may advantageously be realized by means of a computer program, which comprises program code means performing one or more steps of said method, when said program is run on a computer. For this reason the scope of the present patent is meant to cover also said computer program and the computer-readable means that comprise a recorded message, such computer-readable means comprising the program code means for performing one or more steps of such method, when such program is run on a computer.

It will be apparent to the person skilled in the art that other alternative and equivalent embodiments of the invention can be conceived and reduced to practice without departing from the scope of the invention.

From the description set forth above it will be possible for the person skilled in the art to embody the invention with no need of describing further construction details. The elements and the characteristics described in the different preferred embodiments may be combined without departing from the scope of the present application.

1. Method for controlling an EGR valve of an internal combustion engine based on a flow model (1), the flow model (1) estimating an EGR flow rate (dmEGR_Est) outgoing from the EGR valve to control an opening/closing of said EGR valve, on the basis of operating parameters (p2, p3, T_EGR) of the internal combustion engine; the method being characterized in that it models said EGR valve as a nozzle and it calculates a relative equivalent outflow area (Aeff) to correct said estimation of the EGR flow rate (dmEGR_Est) outgoing form the EGR valve.

2. Method according to claim 1, wherein said control method further comprises the calculation of a flow rate error (dmEGR_Err) calculated by means of said estimated flow rate (dmEGR_Est) with respect to a reference value (dmEGR_Est) and a feedback step of said flow rate error in the calculation of said equivalent outflow area (Aeff).

3. Method according to claim 2, wherein said feedback comprises a filtering by means of a regulator (2).

4. Method according to claim 3, wherein said regulator (2) is of the PID type.

5. Method according to claim 3, wherein the gains of the regulator are fixed.

6. Method according to claim 3, wherein the gains of the regulator are variable
as a function of an operating point (rpm) of the internal combustion engine and/or
as a function of an amplitude of said estimation error (dmEGR_Eff) and/or
as a function of a sign (+/−) of said estimation error (dmEGR_Eff) and/or
as a function of control policies of the exhaust gas recirculation.

7. Method according to claim 1, wherein the calculation of the equivalent area (Aeff) is a function of the operating point of the internal combustion engine (IC).

8. Method according to claim 1, wherein said operating parameters of the internal combustion engine comprise
(p2) a pressure measured downstream of the EGR valve, namely at the intake manifold (IP) of the internal combustion engine;
(p3) a pressure measured upstream of the EGR valve, namely at the exhaust manifold (OP) of the internal combustion engine;
(T_EGR) a temperature measured upstream of the EGR valve, namely at the intake manifold (IP) of the internal combustion engine;

9. Control device (ECI) the EGR valve of an internal combustion engine based on a flow model (1) comprising
(p2) a pressure sensor downstream of the EGR valve;
(p2) a pressure sensor upstream of the EGR valve;
(T_EGR) a temperature sensor upstream of the EGR valve;
calculation means to perform all the steps of claim 1.

10. Computer program comprising program code means suitable for performing all the steps of claim 1, when such program is run on a computer.

11. Computer-readable means comprising a recorded program, said computer-readable means comprising program code means suitable for performing all the steps according to claim 1, when said program is run on a computer.

12. Internal combustion engine comprising a control device (ECI) according to claim 9.

13. Ground vehicle comprising an internal combustion engine according to claim 12.
